(19) United States
(12) Patent Application Publication
(10) Pub. No.: US 2024/0352568 A1
(43) Pub. Date: Oct. 24, 2024

(54) METAL FUME REDUCTION APPARATUS FOR SNOUT, SNOUT APPARATUS, AND PLATING FACILITY

(71) Applicant: PRIMETALS TECHNOLOGIES JAPAN, LTD., Hiroshima-shi, Hiroshima (JP)

(72) Inventor: Takanori NAGAI, Hiroshima-shi (JP)

(73) Assignee: PRIMETALS TECHNOLOGIES JAPAN, LTD., Hiroshima-shi, Hiroshima (JP)

(21) Appl. No.: 18/685,099

(22) PCT Filed: Oct. 28, 2021
(86) PCT No.: PCT/JP2021/039786

§ 371 Date: Feb. 20, 2024

(51) Int. Cl. C23C 2/00; F27D 17/00

(52) U.S. Cl. CPC C23C 2/004; F27D 17/002

(57) ABSTRACT

A metal fume reduction apparatus for a snout disposed between an outlet of a heat treatment furnace and a molten metal plating tank, includes: a main pipe part; an introduction pipe part and a return pipe part each of which is configured to couple the snout to the main pipe part so that an interior space of the snout communicates with the main pipe part; and a cooling part configured to cool a cooling target site, of the main pipe part, located between a first connection portion with the introduction pipe part and a second connection portion with the return pipe part in a longitudinal direction of the main pipe part. The cooling target site is located below the first connection portion of the main pipe part in a state where the main pipe part is coupled to the snout via the introduction pipe part and the return pipe part.

### TECHNICAL FIELD

The present disclosure relates to a metal fume reduction apparatus for a snout, a snout apparatus, and a plating facility.

### BACKGROUND

In a molten metal plating facility for plating a metal strip (a steel strip, etc.) with a molten metal, a snout enclosing the strip is disposed between an outlet of a heat treatment furnace for heat treating the strip and a plating tank where the molten metal is stored. The snout is disposed such that a distal end portion (lower end portion) thereof is immersed in the molten metal in the plating tank, thereby suppressing entry of air into the snout.

Vapor from which the molten metal in the plating tank evaporates exists in the snout, and this metal vapor condenses and fixes to form metal fumes which may deposit on an inner wall surface, etc. of the snout. If such deposited metal fumes (also called ash) peel off from the inner wall surface of the snout and adhere to the strip to be plated, the deposited metal fumes can cause a plating defect and may impair strip quality. Therefore, it is necessary to reduce the metal fumes in the snout.

Patent Document 1 discloses a snout cleaning apparatus in which a snout is disposed connectedly to a suction duct kept warm at not lower than a melting point of a plated metal, a cooler, and a filter device for removing a vaporized metal and its compound. In this apparatus, a gas in the snout is suctioned into a suction duct by a blower, the suctioned gas is cooled by the cooler to solidify a metal contained in the gas, and the solidified metal is removed by the filter device.

Patent Document 2 discloses an apparatus for preventing ash generation in a snout, which includes a duct connected to a snout at both ends (a suction port and a discharge port), an ejector means for ejecting an inert gas into the duct, and a separator disposed upstream of the ejector means in the duct. In this apparatus, the inert gas is ejected into the duct by the ejector means to draw the gas in the snout into the duct and forcibly convect the gas in the duct, as well as plating metal vapor in the gas passing through the separator is condensed in the separator, separated from the gas, and collected.

### CITATION LIST

### Patent Literature

Patent Document 1: JPH6-306555A
Patent Document 2: JP4436122B

### SUMMARY

### Technical Problem

In the apparatus disclosed in Patent Document 1 or Patent Document 2, an apparatus configuration is complex since the blower or the ejector means is used to draw the gas containing metal vapor in the snout into the duct and circulate the gas.

In view of the above, an object of at least one embodiment of the present invention is to provide a metal fume reduction apparatus for a snout, which can reduce metal fumes in the snout with a simple configuration, a snout apparatus, and a plating facility.

### Solution to Problem

A metal fume reduction apparatus for a snout according to at least one embodiment of the present invention is a metal fume reduction apparatus for a snout disposed between an outlet of a heat treatment furnace and a molten metal plating tank, including: a main pipe part; an introduction pipe part and a return pipe part each of which is configured to couple the snout to the main pipe part so that an interior space of the snout communicates with the main pipe part; and a cooling part configured to cool a cooling target site, of the main pipe part, located between a first connection portion with the introduction pipe part and a second connection portion with the return pipe part in a longitudinal direction of the main pipe part. The cooling target site is located below the first connection portion of the main pipe part in a state where the main pipe part is coupled to the snout via the introduction pipe part and the return pipe part.

Further, a snout apparatus according to at least one embodiment of the present invention, includes: a snout disposed between an outlet of a heat treatment furnace and a molten metal plating tank; and the above-described metal fume reduction apparatus configured to reduce metal fumes in the snout.

Furthermore, a plating facility according to at least one embodiment of the present invention, includes: the above-described snout apparatus; and a plating tank configured to store a molten metal. The plating facility is configured such that a lower end portion of the snout is immersed in the molten metal in the plating tank.

### Advantageous Effects

According to at least one embodiment of the present invention, provided are a metal fume reduction apparatus for a snout, which can reduce metal fumes in the snout with a simple configuration, a snout apparatus, and a plating facility.

### BRIEF DESCRIPTION OF DRAWINGS

FIG. 1 is a schematic configuration view of a plating facility to which a metal fume reduction apparatus is applied according to an embodiment.

FIG. 2 is a schematic view of a snout apparatus including the metal fume reduction apparatus according to an embodiment.

FIG. 3 is a schematic view of the snout apparatus including the metal fume reduction apparatus according to an embodiment.

FIG. 4 is a schematic view of the snout apparatus including the metal fume reduction apparatus according to an embodiment.

FIG. 5 is a schematic view of the snout apparatus including the metal fume reduction apparatus according to an embodiment.

FIG. 6 is a schematic view of the snout apparatus including the metal fume reduction apparatus according to an embodiment.

FIG. 7 is a schematic view of the snout apparatus including the metal fume reduction apparatus according to an embodiment.

FIG. 8 is a partial enlarged view of the metal fume reduction apparatus shown in FIG. 7.

### DETAILED DESCRIPTION

Some embodiments of the present invention will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present invention.

### Configuration of Plating Facility

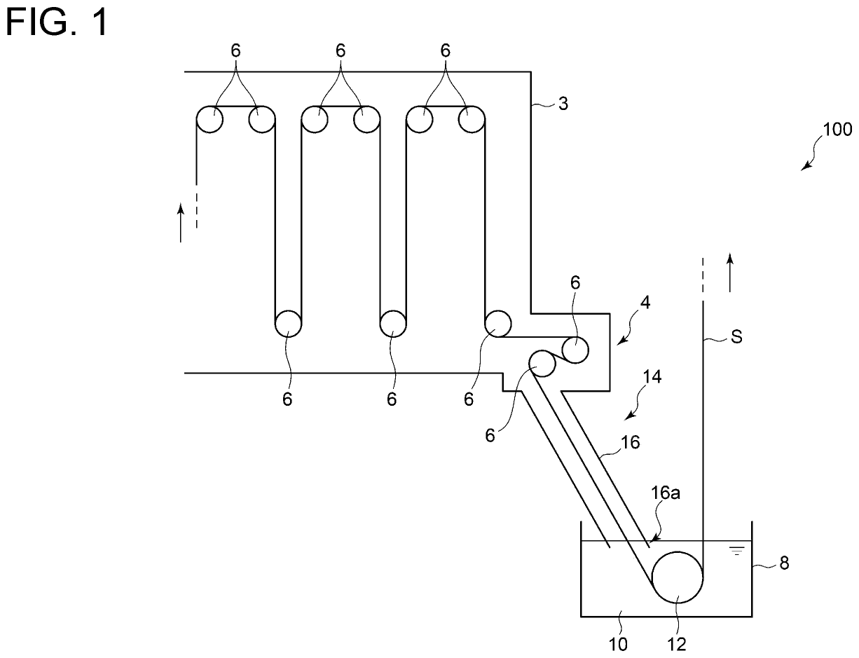

FIG. 1 is a schematic configuration view of a plating facility to which a metal fume reduction apparatus is applied according to an embodiment. As shown in FIG. 1, a plating facility 100 is a facility for continuously plating a metal strip S (such as a steel strip), and includes a heat treatment furnace 3 for heat treating the strip S, and a plating tank 8 (molten metal pot) disposed outside the heat treatment furnace 3 and forming a plating bath of a molten metal 10.

The heat treatment furnace 3 is a device for heat treating the strip S passing through the inside of the heat treatment furnace 3 and, for example, may be configured to continuously anneal the strip S. The interior of the heat treatment furnace 3 is provided with a plurality of rolls 6. These rolls 6 are configured to convey the strip S by applying tension to the strip S or changing a direction of the strip S. Whereby, the strip S can continuously be treated. An arrow in FIG. 1 represents a conveying direction of the strip S. The interior of the heat treatment furnace 3 may be supplied with a reducing or non-oxidizing gas.

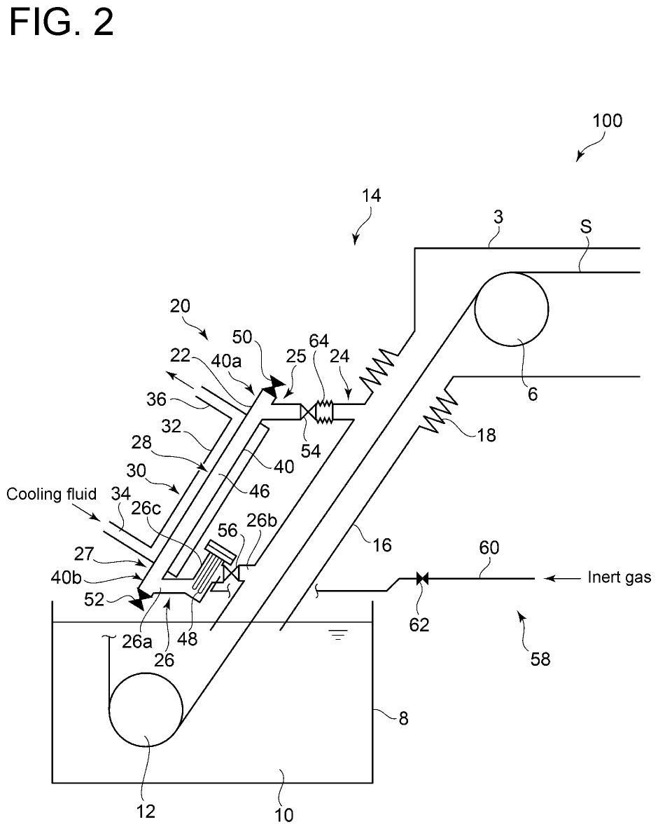

A snout apparatus 14 is disposed between an outlet portion 4 of the heat treatment furnace 3 and the plating tank 8. The snout apparatus 14 includes a snout 16 which is a tubular member forming a passage for the strip S, and a metal fume reduction apparatus (not shown in FIG. 1) described later. A lower end portion 16a (that is, a distal end portion) of the snout 16 is disposed to be immersed in the molten metal 10 (plating bath) stored in the plating tank 8. Whereby, an outflow of a gas from the inside to the outside of the heat treatment furnace 3 and the snout 16 or an inflow of a gas (such as air) from the outside to the inside of the heat treatment furnace 3 and the snout 16 is prevented. The snout 16 may be provided with an expansion part 18 for moving a distal end of the snout 16 in and out of the molten metal or for adjusting an angle of the snout (see FIGS. 2 to 7).

The plating tank 8 stores the molten metal 10 as a plating solution and forms the plating bath. The type of molten metal stored in the plating tank 8 is not particularly limited. For example, if the strip S is a steel strip, the molten metal may be zinc or aluminum, or an alloy containing these.

Further, a sink roll 12 is disposed in the plating tank 8. The strip S introduced from the inside of the heat treatment furnace 3 to the plating bath of the molten metal 10 through the snout 16 is diverted upward by the sink roll 12, so that the strip S with the molten metal adhering to a surface thereof moves upward of the plating tank 8.

A wiping nozzle (not shown) may be disposed downstream of the sink roll 12 in the conveying direction of the strip S, in order to adjust a thickness of the plating solution (molten metal) adhering to the strip S, by blowing a gas toward the conveyed strip S.

### Configuration of Metal Fume Reduction Apparatus

FIGS. 2 to 7 are each a schematic view of the plating facility with the snout apparatus 14 including the metal fume reduction apparatus according to an embodiment.

A metal fume reduction apparatus 20 shown in FIGS. 2 to 7 includes a main pipe part 22, an introduction pipe part 24 for introducing the gas in the snout 16 into the main pipe part 22, and a return pipe part 26 for returning the gas in the main pipe part 22 into the snout 16. The main pipe part 22 is connected to the introduction pipe part 24 in a first connection portion 25 and is connected to the return pipe part 26 in a second connection portion 27. The introduction pipe part 24 and the return pipe part 26 are disposed so as to couple the snout 16 to the main pipe part 22, respectively, so that an interior space of the snout 16 communicates with the main pipe part 22. The introduction pipe part 24, the main pipe part 22, and the return pipe part 26 form a flow path 46 for allowing the gas from the inside of the snout 16 to be distributed in this order.

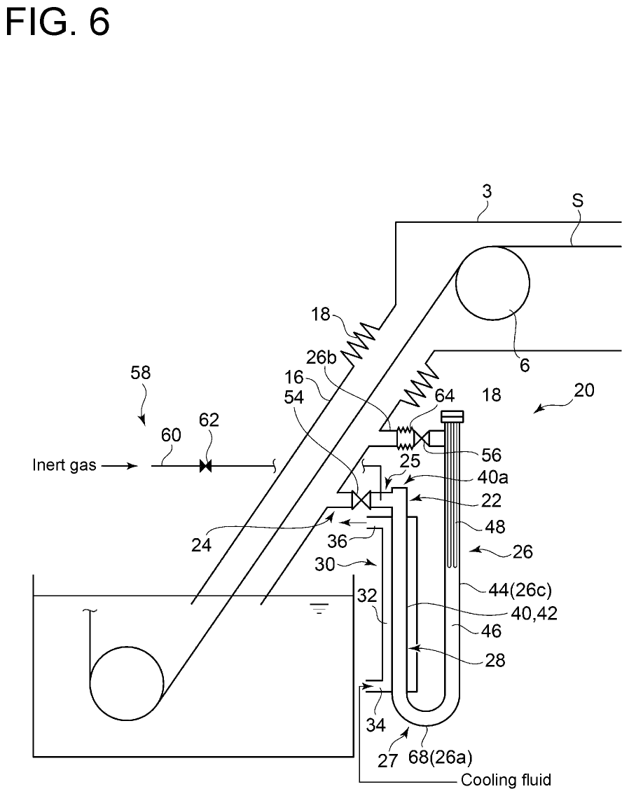

The introduction pipe part 24, the main pipe part 22, and the return pipe part 26 may be disposed above the snout 16 as shown in FIGS. 2 to 5, for example, or may be disposed below the snout 16 as shown in FIG. 6, for example.

Further, the metal fume reduction apparatus 20 includes a cooling part 30 for cooling a cooling target site 28 of the main pipe part 22. The cooling target site 28 of the main pipe part 22 is located between the first connection portion 25 and the second connection portion 27 in a longitudinal direction of the main pipe part 22.

The cooling part 30 may be configured to cool an outer surface of the cooling target site 28 of the main pipe part 22 by a cooling fluid. In the exemplary embodiments shown in FIGS. 2 to 7, the cooling part 30 includes a jacket portion 32 covering the outer surface of the cooling target site 28, a supply portion 34 for supplying the cooling fluid (such as water) into the jacket portion 32, and a discharge portion 36 for discharging the cooling fluid from the jacket portion 32, and is configured to cool the cooling target site 28 via the jacket portion 32 by supplying the cooling fluid into the jacket portion 32.

In some embodiments, the cooling part 30 may be configured to cool the cooling target site 28 of the main pipe part 22 by directly supplying the cooling fluid to the cooling target site 28.

As shown in FIGS. 2 to 7, the cooling target site 28 of the main pipe part 22 is located below the first connection portion 25 of the main pipe part 22 in a state where the main pipe part 22 is coupled to the snout 16 via the introduction pipe part 24 and the return pipe part 26.

In the above configuration, since, of the main pipe part 22 into which the gas from the snout 16 is introduced via the introduction pipe part 24, the cooling target site 28 located below the first connection portion 25 between the main pipe part 22 and the introduction pipe part 24 is cooled, the gas in the main pipe part 22 near the cooling target site 28 is cooled and increased in specific gravity, forming a downward flow in the main pipe part 22. Thus, the gas can be distributed by natural convection in the flow path 46 formed by the introduction pipe part 24, the main pipe part 22, and the return pipe part 26. Therefore, even without using a device such as a blower or an ejector means, it is possible to continuously perform a series of processes of introducing the gas in the snout 16 into the main pipe part 22 from the introduction pipe part 24, condensing, by cooling in the cooling part 30, the metal vapor contained in the gas and further solidifying the gas (also including a case of fixation without going through solidification), and returning the gas from which solidified metal is removed into the snout 16 from the return pipe part 26. As described above, despite the simple configuration, it is possible to reduce metal vapor in the snout 16 and metal fumes caused by the metal vapor.

The solidified metal produced in the main pipe part 22 by cooling the gas in the cooling part 30 can be taken out of the main pipe part 22 via a first valve 50 or a second valve 52 described later, by opening the first valve 50 or the second valve 52, for example.

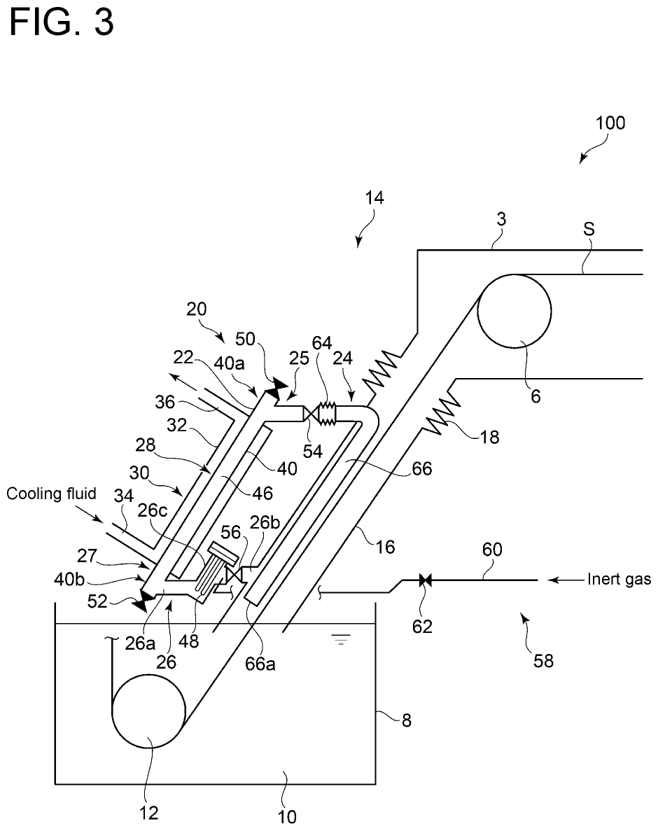

In some embodiments, for example, as shown in FIGS. 2 and 3, the main pipe part 22 includes a straight pipe portion 40 extending linearly. The introduction pipe part 24 is connected to an end portion (first end portion 40a) of the straight pipe portion 40, and the return pipe part 26 is connected to another end portion (second end portion 40b) of the straight pipe portion 40.

In this case, the flow path 46 through which the gas introduced from the snout 16 flows can be formed with the simple configuration where the introduction pipe part 24 and the return pipe part 26 are connected to the both end portions of the straight pipe portion 40 (main pipe part 22) extending linearly.

In some embodiments, for example, as shown in FIG. 3, the introduction pipe part 24 may be connected to an extension pipe 66 extending inside the snout 16 along an extension direction of the snout 16 (that is, the conveying direction of the strip S). As shown in FIG. 3, the extension pipe 66 may have an end opening 66a (lower end opening) located below a connection position between the return pipe part 26 and the snout 16.

In this case, since the end opening 66a of the extension pipe 66 is located below the connection position between the return pipe part 26 and the snout 16, a gas existing relatively below inside the snout 16 and containing relatively high concentration of metal vapor is introduced into the main pipe part 22 including the cooling target site 28 via the end opening 66a. Therefore, it is possible to efficiently reduce the metal fumes in the snout 16.

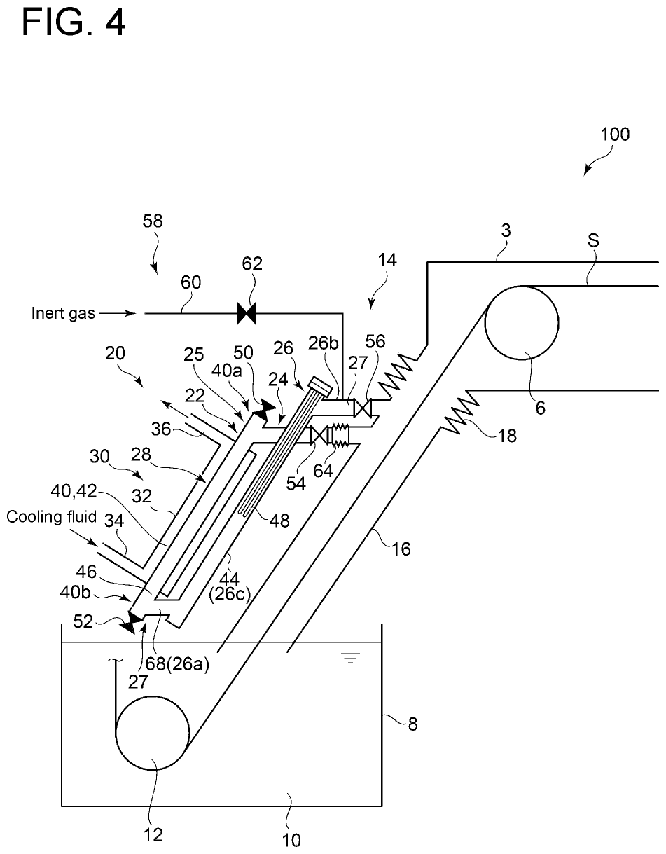

In some embodiments, for example, as shown in FIGS. 4 to 6, the return pipe part 26 is connected to the snout 16 at a position above the introduction pipe part 24. That is, in some embodiments, the connection position between the return pipe part 26 and the snout 16 is located above the connection position between the introduction pipe part 24 and the snout 16.

In the above-described embodiment, since the introduction pipe part 24 is connected to the snout 16 at the position below the return pipe 26 part, the gas existing relatively below inside the snout 16 and containing relatively high concentration of metal vapor is introduced into the main pipe part 22 including the cooling target site 28 via the introduction pipe part 24. Therefore, it is possible to efficiently reduce the metal fumes in the snout 16. Further, in the above-described embodiment, since the return pipe part 26 is connected to the snout 16 at the position above the introduction pipe part 24, the gas from which the solidified metal is removed by passing through the main pipe part 22 including the cooling target site 28 is returned to a relatively upper position inside the snout 16. Therefore, it is possible to effectively suppress entry of the metal vapor or the metal fumes into the heat treatment furnace 3 via the snout 16.

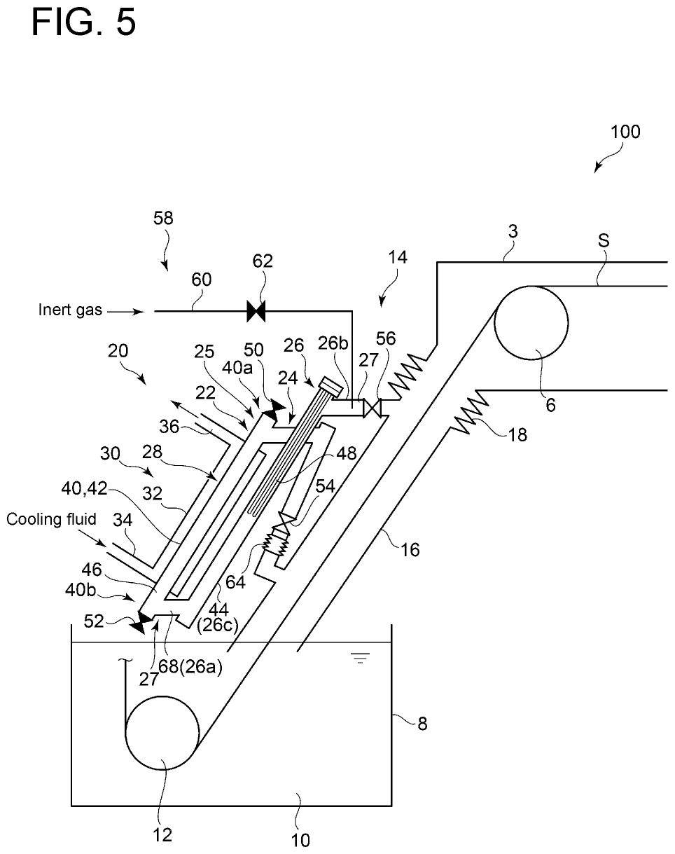

As shown in FIG. 5, the connection position between the introduction pipe part 24 and the snout 16 may be located below the connection position (the position of the first connection portion 25) between the introduction pipe part 24 and the main pipe part 22. Whereby, the gas existing further below the interior of the snout 16 and containing relatively high concentration of metal vapor is introduced into the main pipe part 22 including the cooling target site 28 via the introduction pipe part 24. Therefore, it is possible to more efficiently reduce the metal fumes in the snout 16.

In the exemplary embodiments shown in FIGS. 4 to 6, the main pipe part 22 includes a first straight pipe portion 42 extending linearly and including the cooling target site 28. The return pipe part 26 includes a second straight pipe portion 44 extending linearly at a position different from the first straight pipe portion 42, when viewed from an extension direction of the first straight pipe portion 42. The second straight pipe portion 44 is connected to the first straight pipe portion 42 via a connecting pipe part 68. Further, the introduction pipe part 24 is connected to the first straight pipe portion 42. The connecting pipe part 68 may have a linear shape as shown in FIG. 4 or 5, or may have a curved shape as shown in FIG. 6.

According to the above-described embodiment, the configuration where the return pipe part 26 is connected to the snout 16 at the position above the introduction pipe part 24 can be achieved by the simple configuration including the first straight pipe portion 42 (main pipe part 22) and the second straight pipe portion 44 (return pipe part 26).

In some embodiments, for example, as shown in FIGS. 2 to 7, the metal fume reduction apparatus 20 includes a heater 48 configured to heat the gas in the flow path 46, which is formed by the introduction pipe part 24, the main pipe part 22, and the return pipe part 26, at a position downstream of the cooling target site 28 in the flow path 46.

As shown in FIGS. 2 to 7, the heater 48 may be configured to heat the gas in flow path 46 at a position different from the cooling target site 28, when viewed from the extension direction of the main pipe part 22. For example, as shown in FIGS. 4 to 6, the heater 48 may be disposed in the second straight pipe portion 44 disposed at the position different from the main pipe part 22 (first straight pipe portion 42) when viewed from the extension direction of the main pipe part 22 (first straight pipe portion 42).

In the above configuration, since the heater 48 is disposed at the position downstream of the cooling target site 28 in the flow path 46 formed by the introduction pipe part 24, the main pipe part 22, and the return pipe part 26, it is possible to heat, with the heater 48, the gas which has passed through the cooling target site 28 and from which the solidified metal is removed. Whereby, the gas cooled in the cooling target site 28 can be returned into the snout 16 after being heated, making it possible to suppress a decrease in temperature in the snout 16. Therefore, it is possible to suppress condensation and fixation of metal vapor (that is, generation of metal fumes) in the snout 16.

Further, in the above configuration, since the heater 48 is disposed at the position downstream of the cooling target site 28 in the flow path 46 formed by the introduction pipe part 24, the main pipe part 22, and the return pipe part 26, it is possible to heat, with the heater 48, the gas which has passed through the cooling target site 28 and from which the solidified metal is removed. Consequently, the specific gravity of the gas downstream of the cooling target site 28 decreases, making it possible to form an upward flow of gas in a downstream portion of the cooling target site 28 in the above-described flow path 46. Therefore, a gas flow by natural convection can more smoothly be formed in the above-described flow path 46.

In some embodiments, the heater 48 may be a cartridge-type sheath heater. In this case, leakage of electricity due to adhesion of metal vapor or solidified metal to the heater 48 is unlikely to occur. In addition, the heater 48 is removed or replaced easily.

In some embodiments, for example, as shown in FIGS. 2 to 7, the heater 48 is disposed in the return pipe part 26.

In this case, since the heater 48 is disposed in the return pipe part 26, the specific gravity of the gas in the return pipe part 26 decreases, making it possible to form an upward flow in the return pipe part 26 of the above-described flow path 46. Therefore, the gas flow by natural convection can more smoothly be formed in the above-described flow path 46.

In some embodiments, for example, as shown in FIGS. 2 to 7, the return pipe part 26 may include a first portion 26a connected to the main pipe part 22, a second portion 26b located above the first portion 26a and connected to the snout, and a third portion 26c disposed between the first portion 26a and the second portion 26b. The heater 48 may be disposed in the third portion 26c of the return pipe part 26.

In this case, since the heater 48 is disposed in the third portion 26c of the return pipe part 26, the gas in the third portion 26c can be heated. Therefore, it is easy to form an upward flow flowing from the first portion 26a of the return pipe part 26 to the second portion 26b located above the first portion 26a. Therefore, the gas flow by natural convection can more smoothly be formed in the above-described flow path 46.

In some embodiments, for example, as shown in FIGS. 2 to 7, at least one of the main pipe part 22, the introduction pipe part 24, or the return pipe part 26 includes a buffer portion 64 for absorbing misalignment due to thermal deformation (expansion or contraction) of the main pipe part 22, the introduction pipe part 24, or the return pipe part 26. In the exemplary embodiments shown in FIGS. 2 to 5 and FIG. 7, the buffer portion 64 is disposed in the introduction pipe part 24. In the exemplary embodiment shown in FIG. 6, the buffer portion 64 is disposed in the return pipe part 26. The buffer portion 64 may include an extendable bellows or flexible pipe.

In the above configuration, since the buffer portion 64 is disposed in the main pipe part 22, the introduction pipe part 24, or the return pipe part 26, even if misalignment (such as axial misalignment) occurs due to thermal deformation (expansion or contraction) of the main pipe part 22, the introduction pipe part 24, or the return pipe part 26 caused by, for example, a temperature difference between the snout 16 and the main pipe part 22, the misalignment can be absorbed by the buffer portion 64. Therefore, a stress that can occur in the main pipe part 22, the introduction pipe part 24, or the return pipe part 26 due to the thermal deformation is reduced, making it possible to suppress damage to the main pipe part 22, the introduction pipe part 24, or the return pipe part 26.

In some embodiments, for example, as shown in FIGS. 2 to 7, the main pipe part 22 includes the straight pipe portion 40 extending linearly. Further, the first valve 50 is disposed in, among both end portions of the straight pipe portion 40, the first end portion 40a on a side of the first connection portion 25 with the introduction pipe part 24 relative to the cooling target site 28. The first valve 50 includes an open/close valve with an opening of a size not less than an inner diameter of the straight pipe portion 40. The open/close valve may be, for example, a ball valve or a damper.

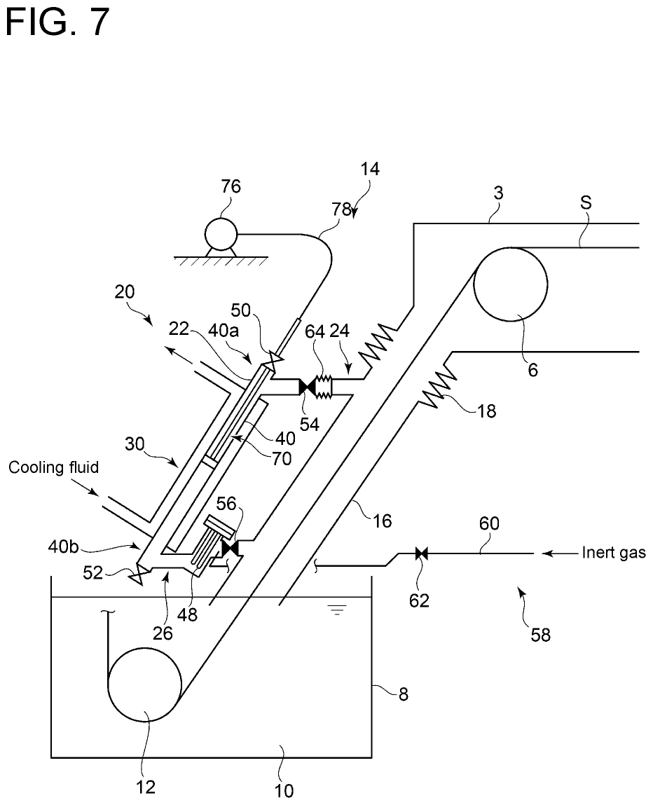

According to the above configuration, the first valve 50 which is the open/close valve is disposed in the first end portion 40a among the both end portions of the straight pipe portion 40, and the size of the opening of the open/close valve is greater than the inner diameter of the straight pipe portion 40. Therefore, when the first valve 50 is open, the solidified metal in the straight pipe portion 40 is easily discharged via the opening of the first valve 50. Alternatively, a cleaning tool or instrument, etc. is easily inserted into the straight pipe portion via the opening (see FIG. 7). Therefore, it is easy to do cleaning of removing the solidified metal from the inside of the main pipe part 22.

In some embodiments, for example, as shown in FIGS. 2 to 7, the second valve 52 is disposed in, among the both end portions of the straight pipe portion 40, the second end portion 40b on a side of the second connection portion 27 with the return pipe part 26 relative to the cooling target site 28. The second valve 52 includes an open/close valve with an opening of a size not less than the inner diameter of the straight pipe portion 40. The open/close valve may be, for example, a ball valve or a damper. The second valve 52 is located below the above-described first valve.

According to the above configuration, the second valve 52 which is the open/close valve is disposed in the second end portion 40b among the both end portions of the straight pipe portion 40, and the size of the opening of the open/close valve is greater than the inner diameter of the straight pipe portion 40. Therefore, when the second valve 52 is open, the solidified metal in the straight pipe portion 40 is easily discharged via the opening of the second valve 52. Alternatively, a cleaning tool or instrument, etc. is easily inserted into the straight pipe portion via the opening. Therefore, it is easy to do cleaning of removing the solidified metal from the inside of the main pipe part 22.

The second valve 52 is preferably connected to a pot. In this case, from above the open second valve 52, the solidified metal (metal oxides, etc.) adhering to an inner wall of the straight pipe portion 40 can be scraped off by a brush, etc. and dropped into the pot for collection.

In some embodiments, the metal fume reduction apparatus 20 may include a vibration part (not shown) for vibrating the straight pipe portion 40. The solidified metal (metal oxides, etc.) adhering to the inner wall of the straight pipe portion 40 can be shaken off by operating the vibration part. In this case, the solidified metal shaken off from the inner wall of the straight pipe portion 40 can be discharged to the outside via the opening of the second valve 52 by opening the second valve 52. Further, the discharged solidified metal can be dropped into the pot for collection by installing the pot below the second valve.

After the solidified metal is thus dropped into the pot, the solidified metal may be removed from the pot by closing the second valve 52.

In some embodiments, for example, as shown in FIGS. 2 to 7, the introduction pipe part 24 is provided with a third valve 54 for switching the communication state between the interior space of the snout 16 and the main pipe part 22. Further, the return pipe part 26 is provided with a fourth valve 56 for switching the communication state between the interior space of the snout 16 and the main pipe part 22.

According to the above configuration, since the third valve 54 and the fourth valve 56 are provided to switch the communication state between the interior space of the snout 16 and the main pipe part 22 via the introduction pipe part 24 and the return pipe part 26, respectively, the communication between the interior of the snout 16 and the main pipe part 22 can be shut off by closing the third valve 54 and the fourth valve 56. Whereby, even during operation of the plating facility 100, by closing the third valve 54 and the fourth valve 56, cleaning, etc. of the main pipe part 22 can be done while suppressing the entry of air from the metal fume reduction apparatus 20 into the snout or diffusion of metal vapor inside the snout 16 to the outside.

In some embodiments, for example, as shown in FIGS. 2 to 7, the metal fume reduction apparatus 20 includes an inert gas supply part 58 configured to supply an inert gas to a position, of the introduction pipe part 24, between the third valve 54 and the main pipe part 22 or a position, of the return pipe part 26, between the fourth valve 56 and the main pipe part 22. The inert gas may be, for example, nitrogen gas.

In the exemplary embodiments shown in FIGS. 2 to 5 and FIG. 7, the inert gas supply part 58 is configured to supply the inert gas to the position, of the return pipe part 26, between the fourth valve 56 and the main pipe part 22. In the exemplary embodiment shown in FIG. 6, the inert gas supply part 58 is configured to supply the inert gas to the position, of the introduction pipe part 24, between the third valve 54 and the main pipe part 22.

The inert gas supply part 58 shown in FIGS. 2 to 7 includes an inert gas supply line 60 disposed between an inert gas supply source (not shown; an inert gas tank, etc.) and the above-described position of the introduction pipe part 24 or the return pipe part 26, and a valve 62 disposed on the inert gas supply line 60 and configured to adjust a supply amount of the inert gas.

According to the above configuration, the inert gas can be supplied to the position, of the introduction pipe part 24 or the return pipe part 26, between the main pipe part 22 and the third valve 54 or the fourth valve 56. Therefore, an area, of the introduction pipe part 24, the main pipe part 22, and the return pipe part 26, between the third valve 54 and the fourth valve 56 can be filled with the inert gas by supplying the inert gas to the above-described position, for example, after the cleaning of the main pipe part 22 is completed, with the third valve 54 and the fourth valve 56 closed and either of the first valve 50 or the second valve 52 valve described above open. Thereafter, the reduction in metal fumes in the snout 16 by the metal fume reduction apparatus 20 can be resumed while preventing air from entering into the snout, by closing the first valve 50 and the second valve 52 and opening the third valve 54 and the fourth valve 56.

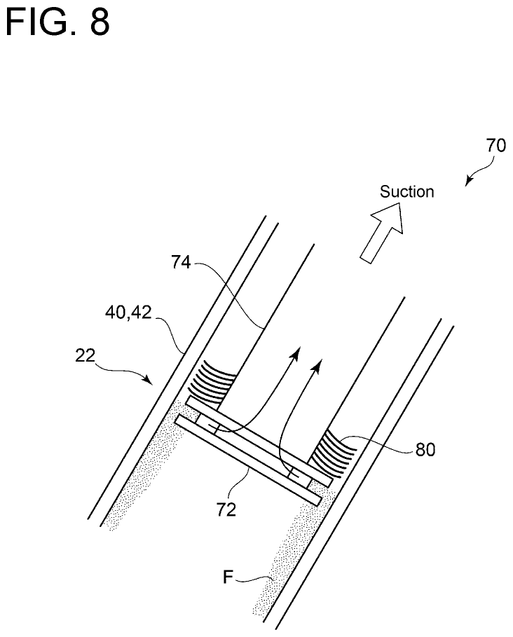

In the exemplary embodiment shown in FIG. 7, the metal fume reduction apparatus 20 includes a suction part 70 for suctioning the solidified metal deposited inside the main pipe part 22. The embodiment shown in FIG. 7 is the same as the embodiment shown in FIG. 2, except that the above-described suction part 70 is provided. Herein, FIG. 8 is a partial enlarged view of the metal fume reduction apparatus 20 shown in FIG. 7.

As shown in FIGS. 7 and 8, the suction part 70 includes a pipe part 74 inserted into the straight pipe portion 40 of the main pipe part 22 via the opening of the first valve 50 (open/close valve), a suction pump 76, and a suction line 78 disposed between the pipe part 74 and the suction pump 76. A disk part 72 having a diameter slightly smaller than the inner diameter of the straight pipe portion 40 is attached to a distal end portion of the pipe part 74 separately from a distal end of the pipe part 74 in a length direction of the pipe part 74. Further, a brush 80 is attached to the distal end portion of the pipe part 74 so as to fill a space between an outer peripheral surface of the pipe part 74 and an inner peripheral surface of the straight pipe portion 40.

A procedure for cleaning the interior of the main pipe part 22 by using the suction part 70 during operation of the plating facility 100 will be described. As shown in FIG. 7, the third valve 54 and the fourth valve 56 are closed during operation of the plating facility 100. Thereafter, the first valve 50 is opened, the pipe part 74 of the suction part 70 is inserted into the straight pipe portion 40 via the opening of the first valve 50, and the suction pump 76 is operated. Then, a solidified metal F (see FIG. 8) adhering to the inner wall of the straight pipe portion 40 is sucked into the pipe part 74 via a gap between the distal end of the pipe part 74 and the disk part 72. Whereby, it is possible to remove the solidified metal F inside the main pipe part 22. Further, by moving the pipe part 74 along the longitudinal direction while operating the suction pump 76, the solidified metal F adhering to the inner wall of the straight pipe portion 40 is scraped off by the disk part 72 and peeled from the inner wall surface, making it easier to suction the solidified metal F by the suction part 70.

After the solidified metal F in the main pipe part 22 is thus removed, the suction pump 76 is stopped and the pipe part 74 is pulled out of the main pipe part 22. Then, the inert gas is supplied by the inert gas supply part 58 in a state where the first valve 50 is opened and the second valve 52, the third valve 54, and the fourth valve 56 are closed. Whereby, the air in the main pipe part 22 can be purged via the first valve 50 and the interior of the main pipe part 22 can be filled with the inert gas. Thereafter, the reduction in metal fumes in the snout 16 by the metal fume reduction apparatus 20 can be resumed while preventing air from entering into the snout 16, by closing the first valve 50 and opening the third valve 54 and the fourth valve 56. The above-described metal fume reduction apparatus may be installed in plural in a strip width direction of the snout apparatus 14.

The contents described in the above embodiments would be understood as follows, for instance.

(1) A metal fume reduction apparatus (20) for a snout (16) according to at least one embodiment of the present invention is a metal fume reduction apparatus for a snout (16) disposed between an outlet of a heat treatment furnace (3) and a molten metal plating tank (8), including: a main pipe part (22); an introduction pipe part (24) and a return pipe part (26) each of which is configured to couple the snout to the main pipe part so that an interior space of the snout communicates with the main pipe part; and a cooling part (30) configured to cool a cooling target site (28), of the main pipe part, located between a first connection portion (25) with the introduction pipe part and a second connection portion (27) with the return pipe part in a longitudinal direction of the main pipe part. The cooling target site is located below the first connection portion of the main pipe part in a state where the main pipe part is coupled to the snout via the introduction pipe part and the return pipe part.

According to the above configuration (1), since, of the main pipe part into which the gas from the snout is introduced via the introduction pipe part, the cooling target site located below the first connection portion between the main pipe part and the introduction pipe part is cooled, the gas in the main pipe part near the cooling target site is cooled and increased in specific gravity, forming a downward flow in the main pipe part. Thus, the gas can be distributed by natural convection in the flow path formed by the introduction pipe part, the main pipe part, and the return pipe part. Therefore, even without using a device such as a blower or an ejector means, it is possible to continuously perform a series of processes of introducing the gas in the snout into the main pipe part from the introduction pipe part, condensing, by cooling in the cooling part, the metal vapor contained in the gas and further solidifying the gas (also including a case of fixation without going through solidification), and returning the gas from which solidified metal is removed into the snout from the return pipe part. As described above, despite the simple configuration, it is possible to reduce metal vapor in the snout and metal fumes caused by the metal vapor.

(2) In some embodiments, in the above configuration (1), the cooling part is configured to cool an outer surface of the main pipe part by a cooling fluid. According to the above configuration (2), with the simple configuration where the outer surface of the main pipe part is cooled by the cooling fluid, the gas can be distributed by natural convection in the flow path formed by the introduction pipe part, the main pipe part, and the return pipe part. Therefore, as described above in (1), despite the simple configuration, it is possible to reduce metal vapor in the snout and metal fumes caused by the metal vapor.

(3) In some embodiments, in the above configuration (1) or (2), the main pipe part includes a straight pipe portion (40) extending linearly, the introduction pipe part is connected to an end portion (40a) of the straight pipe portion, and the return pipe part is connected to another end portion (40b) of the straight pipe portion.

According to the above configuration (3), the flow path through which the gas introduced from the snout flows can be formed with the simple configuration where the introduction pipe part and the return pipe part are connected to the both end portions of the straight pipe portion (main pipe part) extending linearly. Therefore, as described above in (1), despite the simple configuration, it is possible to reduce metal vapor in the snout and metal fumes caused by the metal vapor.

(4) In some embodiments, in the above configuration (1) or (2), the return pipe part is configured to be connected to the snout at a position above the introduction pipe part.

According to the above configuration (4), since the introduction pipe part is connected to the snout at the position below the return pipe part, the gas existing relatively below inside the snout and containing relatively high concentration of metal vapor is introduced into the main pipe part including the cooling target site via the introduction pipe part. Therefore, it is possible to efficiently reduce the metal fumes in the snout. Further, according to the above configuration (4), since the return pipe part is connected to the snout at the position above the introduction pipe part, the gas from which the solidified metal is removed by passing through the main pipe part including the cooling target site is returned to a relatively upper position inside the snout. Therefore, it is possible to effectively suppress entry of the metal vapor or the metal fumes into the heat treatment furnace via the snout.

(5) In some embodiments, in the above configuration (4), the main pipe part includes a first straight pipe portion (42) extending linearly and including the cooling target site, the return pipe part includes a second straight pipe portion (44) extending linearly at a position different from the first straight pipe portion and connected to the first straight pipe portion via a connecting pipe part (68), when viewed from an extension direction of the first straight pipe portion, and the introduction pipe part is connected to the first straight pipe portion.

According to the above configuration (5), the above configuration (4) (the configuration where the return pipe part is connected to the snout at the position above the introduction pipe part) can be realized by the simple configuration including the first straight pipe portion (main pipe part) and the second straight pipe portion (return pipe part).

(6) In some embodiments, in any of the above configurations (1) to (5), the introduction pipe part, the main pipe part, and the return pipe part form a flow path (46) for allowing a gas from the snout to be distributed in this order, and the metal fume reduction apparatus includes a heater (48) configured to heat the gas in the flow path at a position downstream of the cooling target site in the flow path.

According to the above configuration (6), since the heater is disposed at the position downstream of the cooling target site in the flow path formed by the introduction pipe part, the main pipe part, and the return pipe part, it is possible to heat, with the heater, the gas which has passed through the cooling target site and from which the solidified metal is removed. Whereby, the gas cooled in the cooling target site can be returned into the snout after being heated, making it possible to suppress a decrease in temperature in the snout. Therefore, it is possible to suppress condensation and fixation of metal vapor (that is, generation of metal fumes) in the snout. Further, since the specific gravity of the gas downstream of the cooling target site is decreased by heating the gas with the above-described heater, it is possible to form an upward flow in a downstream portion of the cooling target site in the above-described flow path. Therefore, the gas flow by natural convection can more smoothly be formed in the above-described flow path.

(7) In some embodiments, in the above configuration (6), the heater is disposed in the return pipe part.

According to the above configuration (7), since the heater is disposed in the return pipe part, the specific gravity of the gas in the return pipe part decreases, making it possible to form an upward flow in the return pipe part of the above-described flow path. Therefore, the gas flow by natural convection can more smoothly be formed in the above-described flow path.

(8) In some embodiments, in any of the above configurations (1) to (7), the main pipe part includes a straight pipe portion (40) extending linearly, the metal fume reduction apparatus includes a first valve (50) disposed in, among both end portions of the straight pipe portion, a first end portion (40a) on a side of the first connection portion with the introduction pipe part relative to the cooling target site, and the first valve includes an open/close valve with an opening of a size not less than an inner diameter of the straight pipe portion.

According to the above configuration (8), the first valve which is the open/close valve is disposed in the first end portion among the both end portions of the straight pipe portion, and the size of the opening of the open/close valve is greater than the inner diameter of the straight pipe portion. Therefore, when the first valve is open, the solidified metal in the straight pipe portion is easily discharged via the opening of the first valve. Alternatively, a cleaning tool or instrument, etc. is easily inserted into the straight pipe portion via the opening. Therefore, it is easy to do cleaning of removing the solidified metal from the inside of the main pipe part.

(9) In some embodiments, in any of the above configurations (1) to (8), the main pipe part includes a straight pipe portion (40) extending linearly, the metal fume reduction apparatus includes a second valve (52) disposed in, among both end portions of the straight pipe portion, a second end portion (49b) on a side of the second connection portion with the return pipe part relative to the cooling target site, and the second valve includes an open/close valve with an opening of a size not less than an inner diameter of the straight pipe.

According to the above configuration (9), the second valve which is the open/close valve is disposed in the second end portion among the both end portions of the straight pipe portion, and the size of the opening of the open/close valve is greater than the inner diameter of the straight pipe portion. Therefore, when the second valve is open, the solidified metal in the straight pipe portion is easily discharged via the opening of the second valve. Alternatively, a cleaning tool or instrument, etc. is easily inserted into the straight pipe portion via the opening. Therefore, it is easy to do cleaning of removing the solidified metal from the inside of the main pipe part.

(10) In some embodiments, in any of the above configurations (1) to (9), the metal fume reduction apparatus includes: a third valve (54) disposed in the introduction pipe part and configured to switch a communication state between the interior space of the snout and the main pipe part; and a fourth valve (56) disposed in the return pipe part and configured to switch the communication state between the interior space of the snout and the main pipe part.

According to the above configuration (10), since the third valve and the fourth valve are provided to switch the communication state between the interior space of the snout and the main pipe part via the introduction pipe part and the return pipe part, respectively, the communication between the interior of the snout and the main pipe part can be shut off by closing the third valve and the fourth valve. Whereby, even during operation of the plating facility, by closing the third valve and the fourth valve, cleaning, etc. of the main pipe part can be done while suppressing the entry of air from the metal fume reduction apparatus into the snout or diffusion of metal vapor inside the snout to the outside.

(11) In some embodiments, in the above configuration (10), the metal fume reduction apparatus includes: an inert gas supply part (58) configured to supply an inert gas to a position, of the introduction pipe part, between the third valve and the main pipe part or a position, of the return pipe part, between the fourth valve and the main pipe part.

According to the above configuration (11), the inert gas can be supplied to the position, of the introduction pipe part or the return pipe part, between the main pipe part and the third valve or the fourth valve. Therefore, an area, of the introduction pipe part, the main pipe part, and the return pipe part, between the third valve and the fourth valve can be filled with the inert gas by supplying the inert gas to the above-described position, for example, after the cleaning of the main pipe part is completed, with the third valve and the fourth valve closed. Thereafter, the reduction in metal fumes by the metal fume reduction apparatus can be resumed while preventing air from entering into the snout, by opening the third valve and the fourth valve.

(12) In some embodiments, in any of the above configurations (1) to (11), at least one of the main pipe part, the introduction pipe part, or the return pipe part includes a buffer portion (64) for absorbing misalignment due to thermal deformation of the main pipe part, the introduction pipe part, or the return pipe part.

According to the above configuration (12), since the buffer portion is disposed in the main pipe part, the introduction pipe part, or the return pipe part, even if misalignment (such as axial misalignment) occurs due to thermal deformation (expansion or contraction) of the main pipe part, the introduction pipe part, or the return pipe part caused by, for example, a temperature difference between the snout and the main pipe part, the misalignment can be absorbed by the buffer portion. Therefore, a stress that can occur in the main pipe part, the introduction pipe part, or the return pipe part due to the thermal deformation is reduced, making it possible to suppress damage to the main pipe part, the introduction pipe part, or the return pipe part.

(13) A snout apparatus (14) according to at least one embodiment of the present invention, includes: a snout (16) disposed between an outlet of a heat treatment furnace and a molten metal plating tank; and the metal fume reduction apparatus (20) according to any one of the above (1) to (12) configured to reduce metal fumes in the snout.

According to the above configuration (13), since, of the main pipe part into which the gas from the snout is introduced via the introduction pipe part, the cooling target site located below the first connection portion between the main pipe part and the introduction pipe part is cooled, the gas in the main pipe part near the cooling target site is cooled and increased in specific gravity, forming a downward flow in the main pipe part. Thus, the gas can be distributed by natural convection in the flow path formed by the introduction pipe part, the main pipe part, and the return pipe part. Therefore, even without using a device such as a blower or an ejector means, it is possible to continuously perform a series of processes of introducing the gas in the snout into the main pipe part from the introduction pipe part, condensing and fixing, by cooling in the cooling part, the metal vapor contained in the gas, and returning the gas from which solidified metal is removed into the snout from the return pipe part. As described above, despite the simple configuration, it is possible to reduce metal vapor in the snout and metal fumes caused by the metal vapor.

(14) A plating facility (100) according to at least one embodiment of the present invention, includes: the snout apparatus (14) as defined in the above (13); and a plating tank (8) configured to store a molten metal (10). The plating facility is configured such that a lower end portion of the snout is immersed in the molten metal in the plating tank.

According to the above configuration (14), since, of the main pipe part into which the gas from the snout is introduced via the introduction pipe part, the cooling target site located below the first connection portion between the main pipe part and the introduction pipe part is cooled, the gas in the main pipe part near the cooling target site is cooled and increased in specific gravity, forming a downward flow in the main pipe part. Thus, the gas can be distributed by natural convection in the flow path formed by the introduction pipe part, the main pipe part, and the return pipe part. Therefore, even without using a device such as a blower or an ejector means, it is possible to continuously perform a series of processes of introducing the gas in the snout into the main pipe part from the introduction pipe part, condensing and fixing, by cooling in the cooling part, the metal vapor contained in the gas, and returning the gas from which solidified metal is removed into the snout from the return pipe part. As described above, despite the simple configuration, it is possible to reduce metal vapor in the snout and metal fumes caused by the metal vapor.

Embodiments of the present invention were described in detail above, but the present invention is not limited thereto, and also includes an embodiment obtained by modifying the above-described embodiments and an embodiment obtained by combining these embodiments as appropriate.

Further, in the present specification, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, an expression of a shape such as a rectangular shape or a cylindrical shape shall not be construed as only the geometrically strict shape, but also includes a shape with unevenness or chamfered corners within the range in which the same effect can be achieved.

As used herein, the expressions “comprising”, “including” or “having” one constitutional element is not an exclusive expression that excludes the presence of other constitutional elements.

### REFERENCE SIGNS LIST

3 Heat treatment furnace
4 Outlet portion
6 Roll
8 Plating tank
10 Molten metal
12 Sink roll
14 Snout apparatus
16 Snout
16a Lower end portion
18 Expansion part
20 Metal fume reduction apparatus
22 Main pipe part
24 Introduction pipe part
25 First connection portion
26 Return pipe part
26a First portion
26b Second portion
26c Third portion
27 Second connection portion
28 Cooling target site
30 Cooling part
32 Jacket portion
34 Supply portion
36 Discharge portion
40 Straight pipe portion
40a First end portion
40b Second end portion
42 First straight pipe portion
44 Second straight pipe portion
46 Flow path
48 Heater
50 First valve
52 Second valve
54 Third valve
56 Fourth valve
58 Inert gas supply part
60 Inert gas supply line
62 Valve
64 Buffer portion
66 Extension pipe
66a End opening
68 Connecting pipe part
70 Suction part
72 Disk part
74 Pipe part
76 Suction pump
78 Suction line
80) Brush
100 Plating facility
F Solidified metal
S Strip

1. A metal fume reduction apparatus for a snout disposed between an outlet of a heat treatment furnace and a molten metal plating tank, comprising:
a main pipe part;
an introduction pipe part and a return pipe part each of which is configured to couple the snout to the main pipe part so that an interior space of the snout communicates with the main pipe part; and
cooling part configured to cool a cooling target site, of the main pipe part, located between a first connection portion with the introduction pipe part and a second connection portion with the return pipe part in a longitudinal direction of the main pipe part,
wherein the cooling target site is located below the first connection portion of the main pipe part in a state where the main pipe part is coupled to the snout via the introduction pipe part and the return pipe part, and
wherein the metal fume reduction apparatus does not comprise a device for suctioning a gas from an inside of the snout to a flow path formed by the main pipe part, the introduction pipe part, and the return pipe part.

2. The metal fume reduction apparatus for the snout according to claim 1,
wherein the cooling part is configured to cool an outer surface of the main pipe part by a cooling fluid.

3. The metal fume reduction apparatus for the snout according to claim 1,
wherein the main pipe part includes a straight pipe portion extending linearly,
wherein the introduction pipe part is connected to an end portion of the straight pipe portion, and
wherein the return pipe part is connected to another end portion of the straight pipe portion.

4. The metal fume reduction apparatus for the snout according to claim 1,
wherein the return pipe part is configured to be connected to the snout at a position above the introduction pipe part.

5. The metal fume reduction apparatus for the snout according to claim 4,
wherein the main pipe part includes a first straight pipe portion extending linearly and including the cooling target site,
wherein the return pipe part includes a second straight pipe portion extending linearly at a position different from the first straight pipe portion and connected to the first straight pipe portion via a connecting pipe part, when viewed from an extension direction of the first straight pipe portion, and
wherein the introduction pipe part is connected to the first straight pipe portion.

6. The metal fume reduction apparatus for the snout according to claim 1,
wherein the introduction pipe part, the main pipe part, and the return pipe part form a flow path for allowing a gas from the snout to be distributed in this order, and
wherein the metal fume reduction apparatus comprises a heater configured to heat the gas in the flow path at a position downstream of the cooling target site in the flow path.

7. The metal fume reduction apparatus for the snout according to claim 6, wherein the heater is disposed in the return pipe part.

8. The metal fume reduction apparatus for the snout according to claim 1,
wherein the main pipe part includes a straight pipe portion extending linearly,
wherein the metal fume reduction apparatus comprises a first valve disposed in, among both end portions of the straight pipe portion, a first end portion on a side of the first connection portion with the introduction pipe part relative to the cooling target site, and
wherein the first valve includes an open/close valve with an opening of a size not less than an inner diameter of the straight pipe portion.

9. The metal fume reduction apparatus for the snout according to claim 1,
wherein the main pipe part includes a straight pipe portion extending linearly,
wherein the metal fume reduction apparatus comprises a second valve disposed in, among both end portions of the straight pipe portion, a second end portion on a side of the second connection portion with the return pipe part relative to the cooling target site, and
wherein the second valve includes an open/close valve with an opening of a size not less than an inner diameter of the straight pipe portion.

10. The metal fume reduction apparatus for the snout according to claim 1, comprising:
a third valve disposed in the introduction pipe part and configured to switch a communication state between the interior space of the snout and the main pipe part; and
a fourth valve disposed in the return pipe part and configured to switch the communication state between the interior space of the snout and the main pipe part.

11. The metal fume reduction apparatus for the snout according to claim 10, comprising:
an inert gas supply part configured to supply an inert gas to a position, of the introduction pipe part, between the third valve and the main pipe part or a position, of the return pipe part, between the fourth valve and the main pipe part.

12. The metal fume reduction apparatus for the snout according to claim 1,
wherein at least one of the main pipe part, the introduction pipe part, or the return pipe part includes a buffer portion for absorbing misalignment due to thermal deformation of the main pipe part, the introduction pipe part, or the return pipe part.

13. A snout apparatus, comprising:
a snout disposed between an outlet of a heat treatment furnace and a molten metal plating tank; and
the metal fume reduction apparatus according to claim 1 configured to reduce metal fumes in the snout.

14. A plating facility, comprising:
the snout apparatus according to claim 13; and
a plating tank configured to store a molten metal,
wherein the plating facility is configured such that a lower end portion of the snout is immersed in the molten metal in the plating tank.
